(19) United States
(12) Patent Application Publication
(10) Pub. No.: US 2025/0140993 A1
(43) Pub. Date: May 1, 2025

(54) LAMINATE TYPE BATTERY

(71) Applicant: TOYOTA JIDOSHA KABUSHIKI KAISHA, Toyota-shi (JP)

(72) Inventors: Yusuke IKEDA, Miyeshi-shi (JP); Kenichi KAKISHITA, Nagoya-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/744,704

(22) Filed: Jun. 17, 2024

(30) Foreign Application Priority Data
Oct. 27, 2023 (JP) 2023-184923

(51) Int. Cl. H01M 50/124; H01M 50/103; H01M 50/15

(52) U.S. Cl. CPC H01M 50/124; H01M 50/103; H01M 50/15; H01M 2220/20

(57) ABSTRACT

A laminate type battery includes an electrode body, and a laminate film that covers and encloses the electrode body, in which: the laminate film includes a film body that covers four surfaces of the electrode body having a rectangular parallelepiped shape, and two lid members that cover two remaining side surfaces of the electrode body respectively; and each of the lid members has a concave shape that is constituted by one bottom plane and four wall planes, an outside surface of the concave shape at the bottom plane or an inside surface of the concave shape at the bottom plane faces the side surface of the electrode body, and outside surfaces of the concave shape at the wall planes are fused with the film body.

### CROSS-REFERENCE TO RELATED APPLICATION

This application claims priority to Japanese Patent Application No. 2023-184923 filed on Oct. 27, 2023, incorporated herein by reference in its entirety.

### BACKGROUND

### 1. Technical Field

The present disclosure relates to a laminate type battery.

### 2. Description of Related Art

Conventionally, there has been studied a laminate type battery in which an electrode body including a positive electrode, a negative electrode and a separator is covered and enclosed by a laminate film.

For example, Japanese Unexamined Patent Application Publication No. 2004-111219 discloses a laminate secondary battery in which electrode terminals are connected to a battery element including positive electrode layers and negative electrode layers alternately stacked with separators interposed in between, the electrode terminals are exposed to the exterior, and the battery element is vacuum-packed by a laminate film. In the laminate secondary battery, the separators, the positive electrode layers and the negative electrode layers have similar shapes to each other. The areas of the separators, the positive electrode layers and the negative electrode layers are gradually decreased in the stacking direction, while the similarity is kept. The section shape of the battery element in the stacking direction is a trapezoidal shape.

### SUMMARY

Conventionally, for example, for the downsizing of a product equipped with a battery, the downsizing of the battery itself is desired. Therefore, also as for a battery in which an electrode body is covered by a laminate film, it is desired to reduce the volume of a space that is made due to the existence of the laminate film, and the like, as much as possible, and to reduce the size of the whole after the enclosing in the laminate film.

The present disclosure has been made in view of the above circumstance, and has an object to provide a laminate type battery having an outer shape in which the width is small.

Means for solving the above problem includes the following aspect.

<1> A laminate type battery comprising:
an electrode body, and
a laminate film that covers and encloses the electrode body, wherein
the laminate film includes
   a film body that covers four surfaces of the electrode body having a rectangular parallelepiped shape, and
   two lid members that cover two remaining side surfaces of the electrode body respectively, and
each of the lid members has a concave shape that is constituted by one bottom plane and four wall planes, an outside surface of the concave shape at the bottom plane or an inside surface of the concave shape at the bottom plane faces a side surface of the electrode body, and outside surfaces of the concave shape at the wall planes are fused with the film body.

<2> The laminate type battery according to <1>, wherein in each of the lid members, the outside surface of the concave shape at the bottom plane faces the side surface of the electrode body.

<3> The laminate type battery according to <2>, wherein fusion portions of each of the lid members are folded to an inside of the concave shape, the fusion portions being portions where the outside surfaces of the concave shape at the wall planes are fused with the film body.

<4> The laminated type battery according to <2> or <3>, wherein at fusion portions of each of the lid members, the film body further covers the wall planes of the lid member by wrapping the wall planes so as to reach inside surfaces of the concave shape at the wall planes, the fusion portions being portions where the outside surfaces of the concave shape at the wall planes are fused with the film body.

The present disclosure can provide a laminate type battery having an outer shape in which the width is small.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view showing a laminate film of a laminate type battery according to an embodiment of the present disclosure;

FIG. 1B is a schematic perspective view showing a laminate film of a laminate type battery according to another embodiment of the present disclosure;

FIG. 2A is a schematic side view showing a modification of the laminate type battery according to the embodiment of the present disclosure;

FIG. 2B is a schematic sectional view showing a modification of the laminate type battery according to the embodiment of the present disclosure;

FIG. 3 is a schematic plan view showing a principal part of a vehicle;

FIG. 4 is a schematic perspective view of a battery module;

FIG. 5 is a plan view showing a state where a top lid of the battery module has been removed; and

FIG. 6 is a schematic view of a battery cell housed in the battery module as viewed from a thickness direction.

### DETAILED DESCRIPTION OF EMBODIMENTS

Embodiments that are examples of the present disclosure will be described below. The descriptions and the examples show exemplary embodiments, and do not limit the scope of the disclosure.

For numerical ranges that are described stepwise in the present specification, an upper limit or lower limit described in a numerical range may be replaced with an upper limit or lower limit in another stepwise described numerical range. Further, for numerical ranges that are described in the present specification, upper limits or lower limits in the numerical ranges may be replaced with values shown in examples.

### Laminate Type Battery

A laminate type battery according to an embodiment of the present disclosure includes an electrode body and a laminate film that covers and encloses the electrode body.

The laminate film includes a film body that covers four surfaces of the electrode body having a rectangular parallelepiped shape, and two lid members that cover two remaining side surfaces of the electrode body respectively.

Each of the lid members has a concave shape that is constituted by one bottom plane and four wall planes, an outside surface of the concave shape at the bottom plane or an inside surface of the concave shape at the bottom plane faces the side surface of the electrode body, and outside surfaces of the wall planes are fused with the film body.

As for batteries, for example, for the downsizing of a product equipped with a battery, the downsizing of the battery itself has been desired. Therefore, also as for a battery in which an electrode body is covered by a laminate film, it is desired to reduce the volume of a space that is made due to the covering by the laminate film, and the like, that is, it is desired to downsize the whole including the laminate film.

In a conventional laminate film type battery, for example, the electrode body is covered by only a single laminate film. In this case, the single laminate film is wound so as to cover four surfaces of the electrode body, and end portions of the laminate film are fused with each other. Thereafter, surplus laminate films on the two remaining side surfaces of the electrode body are folded around the two remaining side surfaces, and then are fused, so that the electrode body is enclosed.

On the other hand, in the laminate type battery according to the embodiment of the present disclosure, four surfaces of the electrode body are covered by the film body, and the two remaining side surfaces (a pair of side surfaces) of the electrode body are covered by two lid members that is separate from the film body. Therefore, it is not necessary to fold and fuse the surplus laminate films around the side surfaces of the electrode body, and it is possible to shorten the length in a width direction (a direction in which the two side surfaces of the electrode body face each other), as the whole of the laminate type battery. As a result, it is possible to reduce the size of the laminate type battery, to improve volumetric efficiency, and to enhance energy density.

Next, the laminate type battery according to the embodiment of the present disclosure will be described in detail with specific examples, using the drawings.

The figures are schematically shown, and sizes and shapes of parts are exaggerated when appropriate, to facilitate understanding.

### First Aspect

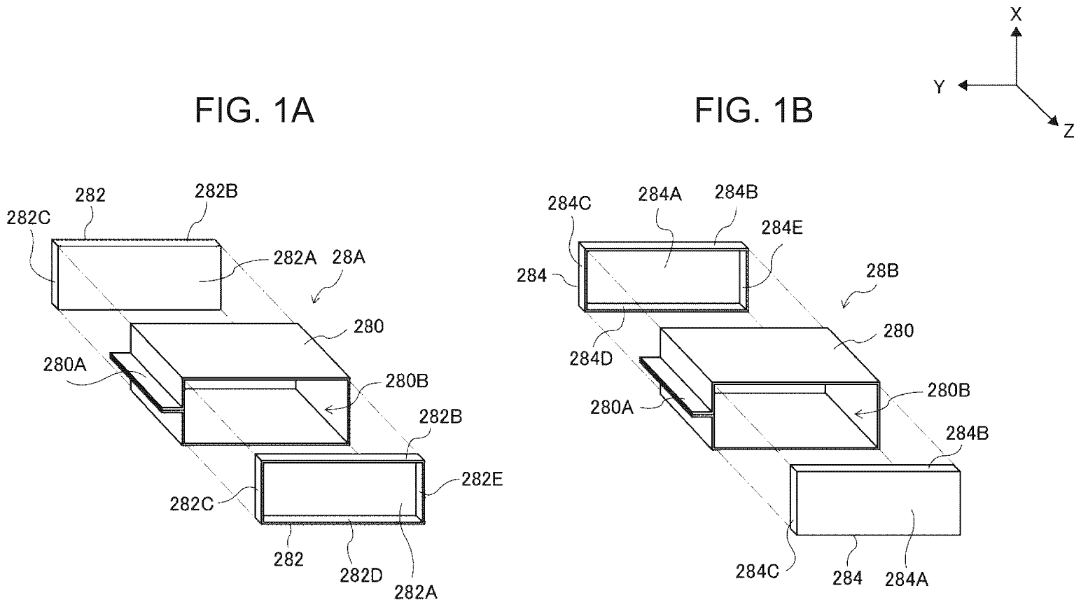

FIG. 1A is a schematic perspective view showing the laminate film of the laminate type battery according to the embodiment of the present disclosure. To facilitate understanding of the configuration of the laminate film that is a characteristic of the present disclosure, in FIG. 1A, the electrode body is not illustrated, and only the laminate film (the film body and the lid members) that covers and encloses the electrode body is illustrated.

A laminate film 28A shown in FIG. 1A includes a film body 280 and two lid members 282. As shown by dotted lines in FIG. 1A, the two lid members 282 are fit so as to enter the inside of the film body 280. Moreover, the electrode body (not illustrated) is covered and enclosed by the laminate film 28A that is constituted by the film body 280 and the two lid members 282.

The film body 280 is constituted by a single film. The film body 280 is wound around the electrode body so as to cover four surfaces of the electrode body, and furthermore, end portions of the film body 280 are fused with each other, so that a body fusion portion 280A is formed. In a state where the electrode body is covered by only the film body 280, two side surfaces (a pair of side surfaces) of the electrode body are exposed.

FIG. 1A shows a configuration in which the film body 280 is constituted by only a single film, but the film body 280 may be constituted by two or more films. For example, a film body including two body fusion portions may be formed by fusing one-side ends of two films with each other and fusing other-side ends of the two film with each other, and this film body may be provided so as to cover the four surfaces of the electrode body.

Each of the two lid members 282 has a concave shape that is constituted by one bottom plane 282A and four wall planes 282B, 282C, 282D, 282E. Moreover, the lid member 282 is fit into the inside of the film body 280, such that an outside surface of the concave shape at the bottom plane 282A faces the side surface of the electrode body (that is, such that the outside surface is oriented to the side of the internal space of the laminate film 28A). Thereby, the two remaining side surfaces of the electrode body that are not covered by the film body 280 are covered by the bottom planes 282A (more specifically, the outside surfaces of the concave shapes at the bottom planes 282A) of the lid members 282, respectively.

Further, each of outside surfaces of the concave shape at the four wall planes 282B, 282C, 282D, 282E of the lid member 282 fit into the inside of the film body 280 contacts with the film body 280. The outsides of the concave shape at the four wall planes 282B, 282C, 282D, 282E and the film body 280 contacting with the wall planes are fused, so that lid fusion portions are formed. Thereby, the electrode body is enclosed in the interior of the laminate film 28A.

In the laminate type battery in which the electrode body is enclosed by the laminate film 28A having this configuration as shown in FIG. 1A, it is possible to shorten the length in the width direction (the direction in which the two side surfaces of the electrode body face each other, that is, the Z-direction in FIG. 1A), as the whole of the laminate type battery. As a result, it is possible to reduce the size of the laminate type battery, to improve volumetric efficiency, and to enhance energy density.

### Modification of First Aspect (Part 1)

Preferably, fusion portions of each of the lid members where the outside surfaces of the concave shape at the wall planes are fused with the film body should be folded to the inside of the concave shape of the lid members.

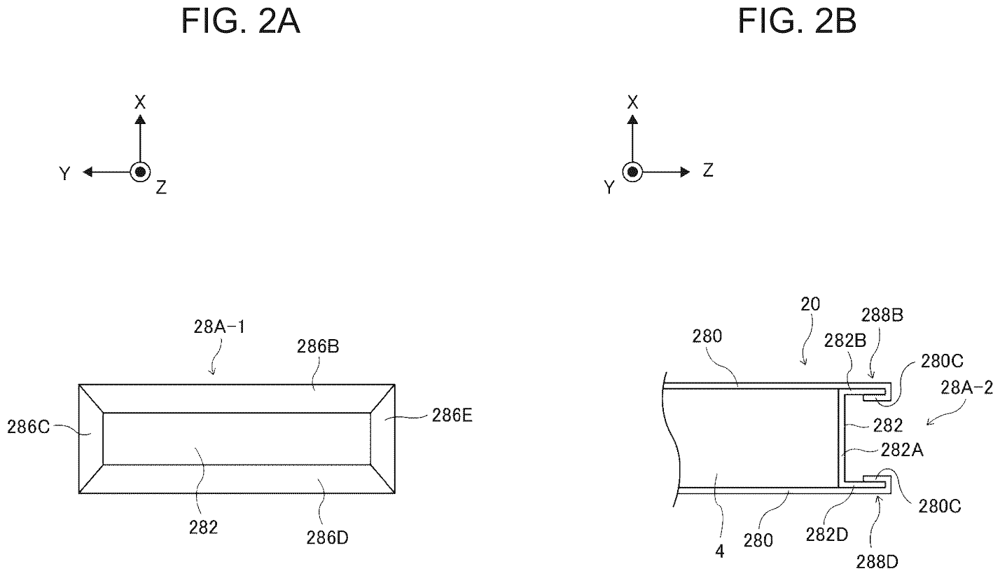

FIG. 2A is a schematic side view showing a modification of the laminate type battery according to the embodiment of the present disclosure. FIG. 2A is a side view of the laminate type battery as viewed from the width direction (the direction in which the two side surface of the electrode body face each other, that is, the Z-direction in FIG. 2A).

In a laminate film 28A-1 shown in FIG. 2A, the outside surfaces of the four wall planes 282B, 282C, 282D, 282E of the lid member 282 fit into the inside of the film body 280 and the film body 280 are fused, so that lid fusion portions 286B, 286C, 286D, 286E are formed. Moreover, each of the lid fusion portions 286B, 286C, 286D, 286E is folded to the inside of the concave shape of the lid member 282. In a manner shown in FIG. 2A, first, the lid fusion portions 286C, 286E are folded to the inside of the concave shape of the lid member 282, and next, the lid fusion portions 286B, 286D are folded to the inside of the concave shape of the lid member 282, so as to cover parts of the lid fusion portions 286C, 286E from the outside.

In the manner shown in FIG. 2A, the lid fusion portions 286C, 286E are first folded to the inside, and the lid fusion portions 286B, 286D are next folded to the inside. However, the manner in which the lid fusion portions are folded is not limited to this. For example, unlike FIG. 2A, the lid fusion portions 286B, 286D may be first folded to the inside of the concave shape of the lid member 282, and the lid fusion portions 286C, 286E may be next folded to the inside of the concave shape of the lid member 282, so as to cover parts of the lid fusion portions 286B, 286D from the outside.

By adopting the configuration in which the fusion portions of the lid member where the outside surfaces of the concave shape at the wall planes are fused with the film body are folded to the inside of the concave shape of the lid member, it is possible to further shorten the length in the width direction (the direction in which the two side surfaces of the electrode body face each other, that is, the Z-direction in FIG. 2A), as the whole of the laminate type battery. As a result, it is possible to reduce the size of the laminate type battery, to improve volumetric efficiency, and to enhance energy density.

### Modification of First Aspect (Part 2)

Preferably, at the fusion portions of each of the lid members where the outside surfaces of the concave shape at the wall planes are fused with the film body, the film body should further cover the wall planes of the lid member by wrapping the wall planes so as to reach inside surfaces of the concave shape at the wall planes.

FIG. 2B is a schematic sectional view showing a modification of the laminate type battery according to the embodiment of the present disclosure. FIG. 2B is a sectional view of the laminate type battery as viewed from a direction (the Y-direction in FIG. 2B) orthogonal to the width direction.

In a laminate film 28A-2 of the battery 20 shown in FIG. 2B, the outside surfaces of the four wall planes (only the two wall planes 282B, 282D are illustrated in FIG. 2B) of the lid member 282 fit into the inside of the film body 280 and the film body 280 are fused, so that lid fusion portions 288B, 288D are formed. In FIG. 2B, only the lid fusion portion 288B where the wall plane 282B is fused and the lid fusion portion 288D where the wall plane 282D is fused are illustrated. However, a lid fusion portion where the wall plane 282C is fused and a lid fusion portion where the wall plane 282E is fused further exist. Moreover, at the lid fusion portions (the four lid fusion portions: the lid fusion portions 288B, 288D shown in FIG. 2B, the lid fusion portion where the wall plane 282C is fused, and the lid fusion portion where the wall plane 282E is fused), the film body 280 wrap the four wall planes (only the two wall planes 282B, 282D are illustrated in FIG. 2B) of the lid member 282 so as to reach the inside surfaces of the concave shape at the four wall planes, so that body wrapping portions 280C are formed. That is, the body wrapping portions 280C of the film body 280 cover also the inside surfaces of the four wall planes of the lid member 282, respectively.

In the manner shown in FIG. 2B, the body wrapping portions 280C of the film body 280 cover parts of the inside surfaces of the four wall planes of the lid member 282. However, the manner in which the film body wraps and covers the four wall planes of the lid member is not limited to this. For example, the film body may cover the whole of the inside surfaces of the four wall planes of the lid member, and the film body may further cover also the inside surface of the bottom plane of the lid member.

In the aspect in which at the fusion portions of the lid member where the outside surfaces of the concave shape at the wall planes are fused with the film body, the film body further covers the wall planes of the lid member by wrapping the wall planes so as to reach the inside surfaces of the concave shape at the wall planes, the fusion portions may be further folded to the inside of the concave shape of the lid member.

By adopting the configuration in which at the fusion portions of the lid member where the outside surfaces of the concave shape at the wall planes are fused with the film body, the film body covers the wall planes of the lid member by wrapping the wall planes so as to reach the inside surfaces of the concave shape at the wall planes, it is possible to widen the range of the fusion portion where the lid member and the film body are fused, and it is possible to further restrain the atmospheric air in the exterior (more specifically, the moisture in the atmospheric air) from entering the internal space that is covered by the laminate film (that is, the space in which the electrode body is enclosed).

### Second Aspect

FIG. 1B is a schematic perspective view showing a laminate film of a laminate type battery according to another embodiment of the present disclosure. To facilitate understanding of the configuration of the laminate film that is a characteristic of the present disclosure, in FIG. 1B, the electrode body is not illustrated, and only the laminate film (the film body and the lid members) that convers and encloses the electrode body is illustrated.

A laminate film 28B shown in FIG. 1B includes a film body 280 and two lid members 284. As shown by dotted lines in FIG. 1B, the two lid members 284 are fit so to enter the inside of the film body 280. Moreover, the electrode body (not illustrated) is covered and enclosed by the laminate film 28B that is constituted by the film body 280 and the two lid members 284.

The film body 280 has the same configuration as the configuration shown in FIG. 1A, and therefore, the description is omitted.

Each of the two lid members 284 has a concave shape that is constituted by one bottom plane 284A and four wall planes 284B, 284C, 284D, 284E. Moreover, the lid member 284 is fit into the inside of the film body 280, such that an inside surface of the concave shape at the bottom plane 284A faces the side surface of the electrode body (that is, such that the inside surface is oriented to the side of the internal space of the laminate film 28B). Thereby, the two remaining side surfaces of the electrode body that are not covered by the film body 280 are covered by the bottom planes 284A (more specifically, the inside surfaces of the concave shapes at the bottom planes 284A) of the lid members 284, respectively.

Further, each of outside surfaces of the concave shape at the four wall planes 284B, 284C, 284D, 284E of the lid member 284 fit into the inside of the film body 280 contacts with the film body 280. The outside surfaces of the concave shape at the four wall planes 284B, 284C, 284D, 284E and the film body 280 contacting with the wall planes are fused, so that lid fusion portions are formed. Thereby, the electrode body is enclosed in the interior of the laminate film 28B.

In the laminate type battery in which the electrode body is enclosed by the laminate film 28B having this configuration as shown in FIG. 1B, it is possible to shorten the length in the width direction (the direction in which the two side surfaces of the electrode body face each other, that is, the Z-direction in FIG. 1B), as the whole of the laminate type battery. As a result, it is possible to reduce the size of the laminate type battery, to improve volumetric efficiency, and to enhance energy density.

Next, a battery module, a battery pack, and a vehicle that include a cell stacked body according to the first or second embodiment of the present disclosure will be described with use of the drawings.

### Overall Configuration of Vehicle 100

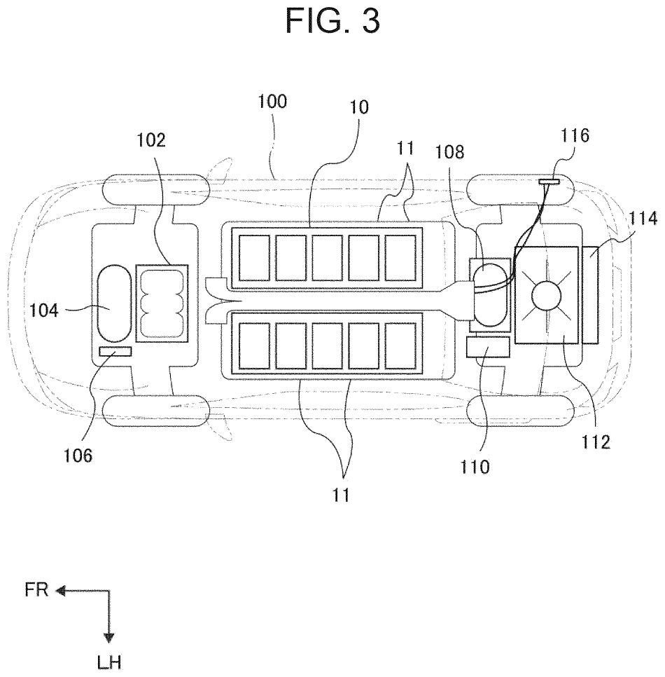

FIG. 3 is a schematic plan view showing a principal part of a vehicle 100 to which a battery pack 10 according to an embodiment is applied. As shown in FIG. 3, the vehicle 100 is a battery electric vehicle (BEV) in which the battery pack 10 is equipped under a floor. In the figures, an arrow UP, an arrow FR, and an arrow LH show the upward direction of the vehicle-height direction, the forward direction of the vehicle front-rear direction, and the leftward direction of the vehicle-width direction, respectively. Forward, rearward, leftward, rightward, upward and downward directions that are used in descriptions mean the forward and downward directions of the vehicle front-rear direction, the leftward and rightward directions of the vehicle-width direction, and the upward and downward directions of the vehicle-height direction, unless otherwise mentioned.

As an example of the vehicle 100 in the embodiment, a DC-DC converter 102, an electric compressor 104, and a positive temperature coefficient (PTC) heater 106 are disposed on a vehicle forward side of the battery pack 10. Further, a motor 108, a gearbox 110, an inverter 112, and a battery charger 114 are disposed on a vehicle rearward side of the battery pack 10.

Direct current output from the battery pack 10 is supplied to the electric compressor 104, the PTC heater 106, the inverter 112, and the like, after the adjustment of the voltage by the DC-DC converter 102. Further, electric power is supplied to the motor 108 through the inverter 112, and thereby rear wheels rotate, so that the vehicle 100 travels.

A charging inlet 116 is provided at a right side portion of a rear portion of the vehicle 100. A charging plug of unillustrated external charging equipment is connected to the charging inlet 116, and thereby, electric power can be stored in the battery pack 10 through the battery charger 114.

Dispositions, structures and others of components that constitute the vehicle 100 are not limited to the above-described configuration. For example, the present disclosure may be applied to a hybrid electric vehicle (HEV) or plug-in hybrid electric vehicle (PHEV) that is equipped with an engine. Further, in the embodiment, a rear-wheel-drive vehicle in which the motor 108 is equipped at the rear portion of the vehicle is adopted. However, without being limited to this, a front-wheel-drive vehicle in which the motor 108 is equipped at a front portion of the vehicle may be adopted, and a pair of motors 108 may be equipped at the front portion and rear portion of the vehicle. Furthermore, a vehicle in which an in-wheel motor is included in each wheel may be adopted.

The battery pack 10 is configured to include a plurality of battery modules 11. In the embodiment, as an example, ten battery modules 11 are provided. Specifically, five battery modules 11 are arrayed in the vehicle front-rear direction on the right side of the vehicle 100, and five battery modules 11 are arrayed in the vehicle front-rear direction on the left side of the vehicle 100. Further, the battery modules 11 are electrically connected to each other.

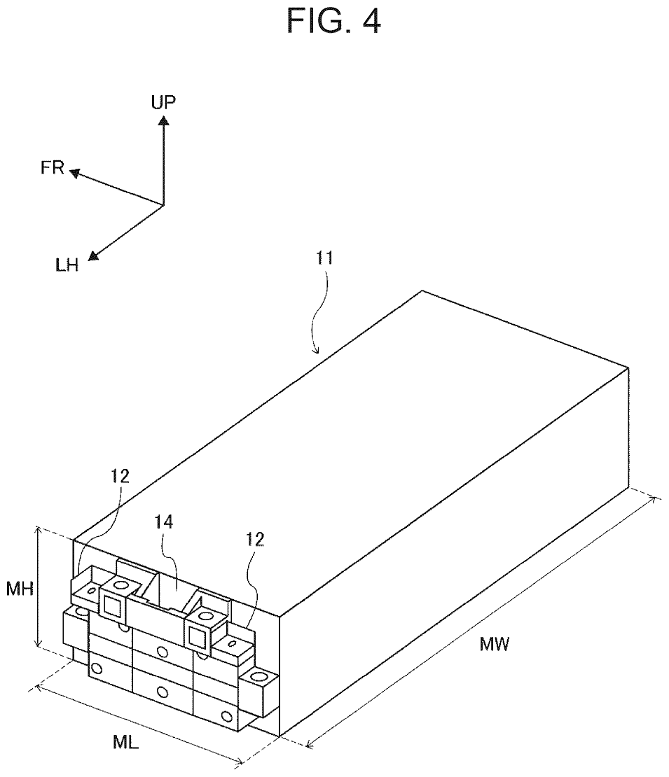

FIG. 4 is a schematic perspective view of the battery module 11. As shown in FIG. 4, the battery module 11 is formed in a roughly rectangular parallelepiped shape in which the longitudinal direction is the vehicle-width direction. Further, an outer shell of the battery module 11 is formed of an aluminum alloy. For example, aluminum die-casts are joined to both end portions of an extruded material composed of the aluminum alloy, by laser welding or the like, and thereby the outer shell of the battery module 11 is formed.

A pair of voltage terminals 12 and a connector 14 are provided on both end portions of the battery module 11 in the vehicle-width direction. A later-described flexible printed wiring board 22 is connected to the connector 14. Further, unillustrated bus bars are welded to both end portions of the battery module 11 in the vehicle-width direction.

A length MW of the battery module 11 in the vehicle-width direction is 350 mm to 600 mm, for example. A length ML in the vehicle front-rear direction is 150 mm to 250 mm, for example. A height MH in the vehicle-height direction is 80 mm to 110 mm, for example.

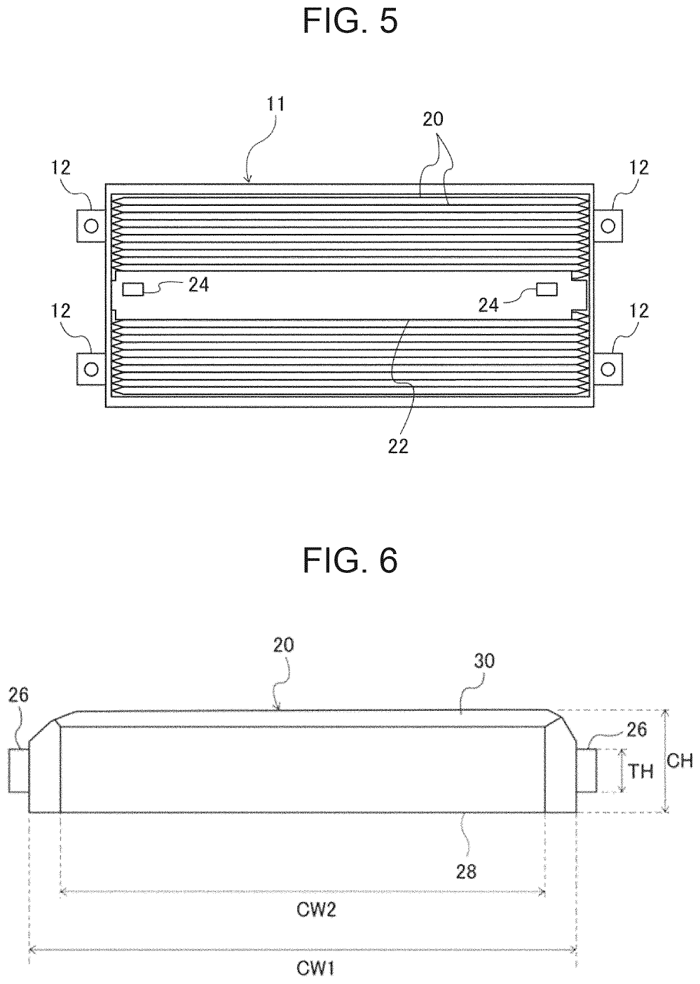

FIG. 5 is a plan view showing a state where a top lid of the battery module 11 has been removed. As shown in FIG. 5, in the interior of the battery module 11, a plurality of battery cells 20 is housed so as to be arrayed. In the embodiment, as an example, 24 battery cells 20 are arrayed in the vehicle front-rear direction, and are bonded to each other.

The flexible printed wiring board (FPC: Flexible Printed Circuit) 22 is disposed on the battery cells 20. The flexible printed wiring board 22 is formed in a belt shape in which the longitudinal direction is the vehicle-width direction, and thermistors 24 are provided at both end portions of the flexible printed wiring board 22, respectively. The thermistors 24 are not bonded to the battery cells 20, and are configured to be pressed to the battery cell 20 side by the top lid of the battery module 11.

Further, a single or a plurality of unillustrated buffer materials is housed in the interior of the battery module 11. For example, the buffer material is a thin-plate member that can elastically deform, and is disposed between adjacent battery cells 20 such that the thickness direction of the buffer material is the arraying direction of the battery cells 20. In the embodiment, as an example, buffer materials are disposed at both longitudinal-directional end portions and longitudinal-directional central portions of the battery module 11.

FIG. 6 is a schematic view of the battery cell 20 housed in the battery module 11 as viewed from a thickness direction. As shown in FIG. 6, the battery cell 20 is formed in a roughly rectangular plate shape, and an unillustrated electrode body is housed in the interior. The electrode body is configured such that a positive electrode, a negative electrode and a separator are stacked, and is sealed by the laminate film 28.

In the embodiment, as an example, the sheet-shaped laminate film 28 after embossing is folded and pasted to each other, and thereby a housing portion for the electrode body is formed. Both a single-cup embossing structure in which embossing is performed at a one spot and a double-cup embossing structure in which embossing is performed at two spots can be employed. In the embodiment, a single-cup embossing structure in which the draw depth is about 8 mm to 10 mm is employed.

Upper ends of both longitudinal-directional end portions of the battery cell 20 are folded, and the corners constitute an outer shape. Further, an upper end portion of the battery cell 20 is folded, and a fixing tape 30 is put on the upper end portion of the battery cell 20 along the longitudinal direction.

Terminals (tabs) 26 are provided at both longitudinal-directional end portions of the battery cell 20, respectively. In the embodiment, as an example, the terminals 26 are provided at offset positions below the center of the battery cell 20 in the height direction of the battery cell 20. The terminals 26 are joined to unillustrated bus bars by laser welding or the like.

A length CW1 of the battery cell 20 in the vehicle-width direction is 530 mm to 600 mm, 600 mm to 700 mm, 700 mm to 800 mm, 800 mm to 900 mm, or 1000 mm or more, for example. A length CW2 of a region where the electrode body is housed is 500 mm to 520 mm, 600 mm to 700 mm, 700 mm to 800 mm, 800 mm to 900 mm, or 1000 mm or more, for example. A height CH of the battery cell 20 is 80 mm to 110 mm, or 110 mm or 140 mm, for example. The thickness of the battery cell 20 is 5.0 mm to 7.0 mm, 7.0 mm to 9.0 mm, or 9.0 mm to 11.0 mm. A height TH of the terminal 26 is 40 mm to 50 mm, 50 mm to 60 mm, or 60 mm to 70 mm.

What is claimed is:

1. A laminate type battery comprising:
an electrode body; and
a laminate film that covers and encloses the electrode body, wherein
the laminate film includes
a film body that covers four surfaces of the electrode body having a rectangular parallelepiped shape, and
two lid members that cover two remaining side surfaces of the electrode body respectively, and
each of the lid members has a concave shape that is constituted by one bottom plane and four wall planes, an outside surface of the concave shape at the bottom plane or an inside surface of the concave shape at the bottom plane faces a side surface of the electrode body, and outside surfaces of the concave shape at the wall planes are fused with the film body.

2. The laminate type battery according to claim 1, wherein in each of the lid members, the outside surface of the concave shape at the bottom plane faces the side surface of the electrode body.

3. The laminate type battery according to claim 2, wherein fusion portions of each of the lid members are folded to an inside of the concave shape, the fusion portions being portions where the outside surfaces of the concave shape at the wall planes are fused with the film body.

4. The laminated type battery according to claim 2, wherein at fusion portions of each of the lid members, the film body further covers the wall planes of the lid member by wrapping the wall planes so as to reach inside surfaces of the concave shape at the wall planes, the fusion portions being portions where the outside surfaces of the concave shape at the wall planes are fused with the film body.
